(19) United States
(12) Patent Application Publication
(10) Pub. No.: US 2022/0070185 A1
(43) Pub. Date: Mar. 3, 2022

(54) METHOD FOR RESPONDING TO THREAT TRANSMITTED THROUGH COMMUNICATION NETWORK

(71) Applicant: LOGPRESSO INC., Seoul (KR)

(72) Inventor: Bongyeol Yang, Seoul (KR)

(21) Appl. No.: 17/387,237

(22) Filed: Jul. 28, 2021

(30) Foreign Application Priority Data
Aug. 25, 2020 (KR) 10-2020-0106709

(51) Int. Cl. H04L 29/06; G06K 9/62

(52) U.S. Cl. CPC H04L 63/1416; H04L 63/1433; H04L 63/1425; G06K 9/6256; H04L 63/20; H04L 63/0236; G06K 9/6264; H04L 63/145

(57) ABSTRACT

A computer-implemented method for responding to network threat includes receiving, by the threat detection module, security-associated data from a unit security system; generating, by the threat detection module, a ticket based on the received security-associated data; requesting, by the ticket management module, ticket analysis and response to the workflow module; calling, by the plugin program module, AIP of the unit security system or an external security service; and carrying out, by the workflow module, a task according to API communication with the called unit security system or the external security service. The task includes at least one of an inquiry task, a blocking task, an alarm task, and a follow-up action task. The inquiry task includes at least one of an inquiry about IP reputation, asset information, WHOIS, GEOIP, URL, HASH, sandbox, and prior information. The blocking task includes at least one of account deactivation, IP blocking, HASH blocking, URL blocking and domain blocking.

### CROSS-REFERENCE TO RELATED APPLICATION

This application claims priority to Korean Patent Application No. 10-2020-0106709 filed on Aug. 25, 2020. The aforementioned application is incorporated herein by reference in its entirety.

### TECHNICAL FIELD

The present disclosure relates to a method for responding to a threat transmitted through communication network, the system and the computer program product performing the method. Particularly, the method of the present disclosure relates to the method of automating a security analyst's decision of the threat and the response to the threat by use of artificial intelligence.

### BACKGROUND

COVID-19 has accelerated digitalization and non-face-to-face in our societies. According to the trend, the number of devices connected to online network and the network traffic are rapidly increasing. The types and number of unit security systems are also rapidly increasing due to the competition between hacking technologies and security technologies. In these circumstances, security-associated data coming to an integral security management platform, for example, security logs, application logs and the like are exploding. Therefore, a security analyst should analyze excessively large amount of data and respond thereto.

The security management system such as SIEM identifies a high-risk threat by use of statistics analysis, correlation analysis, anomaly detection and the like, thereby minimizing the threat alert to the extent that the security manager can respond. However, according to the prior arts, some high-risk threats are likely to be undetected. According to the conventional security management system, a security analyst analyzes the threat and then decides whether to respond to the threat. Thus, it is inevitable that MTTR (Mean Time to Respond) between the detection of the threat and the response thereto becomes longer. Therefore, data destruction and information leakage are likely to occur even though the threat is successfully detected.

Further, the detection method of the conventional security management system depends upon one-way logs which are received by SYSLOG, SNMP and the like. However, the number of the logs to be analyzed are too large and the packet length is too short to have enough information. Recently, many security solutions which provide various analysis information for determining the threat via management console or API are developed and released. However, whenever the threat is detected by the security management system, a security analyst should login to the security solution and search the threat source to carry out behavior analysis or to check traffic metadata, because the information which is provided to security management system is limited. Thus, the prior art cannot unify the threat analysis and the response to the threat and cannot reduce the amount of time the security analyst spends.

### SUMMARY

The object of the present disclosure is to provide a method for responding to a network threat, which assists a security analyst in making decision by learning collected threat analysis information, vulnerability information, asset information and determination results. The object of the present disclosure is also to provide a system and a computer program product performing the method.

The present disclosure provides a computer-implemented method for responding to network threat, carried out by a threat responding device including a threat detection module, a ticket management module, a workflow module and a plugin program module. The method of the present disclosure comprises receiving, by the threat detection module, security-associated data from a unit security system; generating, by the threat detection module, a ticket based on the received security-associated data; requesting, by the ticket management module, ticket analysis and response to the workflow module; calling, by the plugin program module, AIP of the unit security system or an external security service; and carrying out, by the workflow module, a task according to API communication with the called unit security system or the external security service. The task comprises at least one of an inquiry task, a blocking task, an alarm task, and a follow-up action task. The inquiry task comprises at least one of an inquiry about IP reputation, an inquiry about asset information, an inquiry about WHOIS, an inquiry about GEOIP, an inquiry about URL, an inquiry about HASH, an inquiry about sandbox, an inquiry about prior information. The blocking task comprises at least one of account deactivation, IP blocking, HASH blocking, URL blocking and domain blocking.

The plugin program module can call API of the unit security system or the external security service by a query.

A workflow instance of each ticket can comprise attack index variable and general variable. Further, each task can carry out I/O in the general variable space.

The threat responding device can further comprise an AI learning module that receives at least one of categorizable variable extracted from the general variable and determination as to whether an attack index is malicious for each module. The received information can be input feature of the AI learning module.

The method of the present disclosure can further comprise accumulating, by the AI learning module, the input feature and the response result provided by a security analyst; carrying out, by the AI learning module, a supervised learning with the accumulated data to generate an AI learning model; and determining, by the workflow module, a threat according to the AI learning model and responding to the treat.

The present disclosure provides the system performing the method of the present disclosure.

The present disclosure provides the computer program product performing the method of the present disclosure.

### BRIEF DESCRIPTION OF DRAWINGS

FIG. 1 is an exemplary environment where the method of the present disclosure is carried out;

FIG. 2 is a flow chart of the method of the present disclosure; and

FIG. 3 an exemplary block diagram of electronic arithmetic device carrying out the present disclosure.

It should be understood that the above-referenced drawings are not necessarily to scale, presenting a somewhat simplified representation of various preferred features illustrative of the basic principles of the disclosure. The specific design features of the present disclosure will be determined in part by the particular intended application and use environment.

### DETAILED DESCRIPTION

Hereinafter, the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

In this specification, the order of each step should be understood in a non-limited manner unless a preceding step must be performed logically and temporally before a following step. That is, except for the exceptional cases as described above, although a process described as a following step is preceded by a process described as a preceding step, it does not affect the nature of the present disclosure, and the scope of rights should be defined regardless of the order of the steps. In addition, in this specification, “A or B” is defined not only as selectively referring to either A or B, but also as including both A and B. In addition, in this specification, the term “comprise” has a meaning of further including other components in addition to the components listed.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. The term “coupled” denotes a physical relationship between two components whereby the components are either directly connected to one another or indirectly connected via one or more intermediary components. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The term “module” or “unit” means a logical combination of a universal hardware and a software carrying out required function.

The terms “first,” “second,” or the like are herein used to distinguishably refer to same or similar elements, or the steps of the present disclosure and they may not infer an order or a plurality.

In this specification, the essential elements for the present disclosure will be described and the non-essential elements may not be described. However, the scope of the present disclosure should not be limited to the invention including only the described components. Further, it should be understood that the invention which includes additional element or does not have non-essential elements can be within the scope of the present disclosure.

The method of the present disclosure can be an electronic arithmetic device.

The electronic arithmetic device can be a device such as a computer, tablet, mobile phone, portable computing device, stationary computing device, server computer etc. Additionally, it is understood that one or more various methods, or aspects thereof, may be executed by at least one processor. The processor may be implemented on a computer, tablet, mobile device, portable computing device, etc. A memory configured to store program instructions may also be implemented in the device(s), in which case the processor is specifically programmed to execute the stored program instructions to perform one or more processes, which are described further below. Moreover, it is understood that the below information, methods, etc. may be executed by a computer, tablet, mobile device, portable computing device, etc. including the processor, in conjunction with one or more additional components, as described in detail below. Furthermore, control logic may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

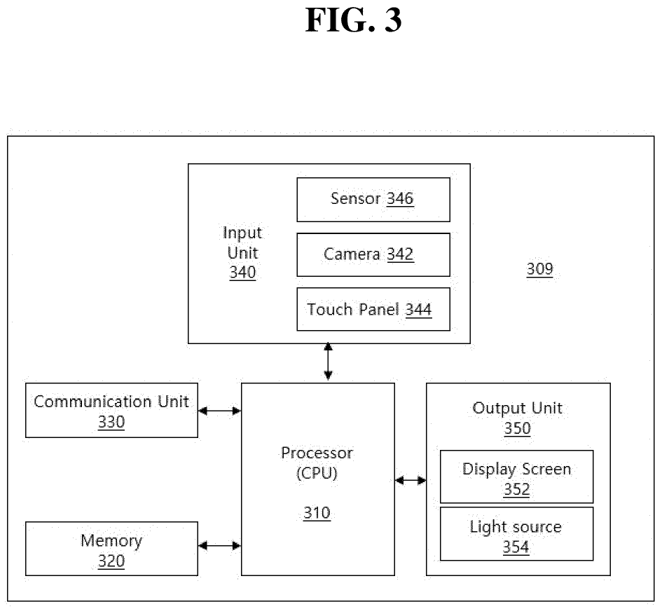

A variety of devices can be used herein. FIG. 3 illustrates an example diagrammatic view of an exemplary device architecture according to embodiments of the present disclosure. As shown in FIG. 3, a device (309) may contain multiple components, including, but not limited to, a processor (e.g., central processing unit (CPU); 310), a memory (320; also referred to as “computer-readable storage media), a wired or wireless communication unit (330), one or more input units (340), and one or more output units (350). It should be noted that the architecture depicted in FIG. 3 is simplified and provided merely for demonstration purposes. The architecture of the device (309) can be modified in any suitable manner as would be understood by a person having ordinary skill in the art, in accordance with the present claims. Moreover, the components of the device (309) themselves may be modified in any suitable manner as would be understood by a person having ordinary skill in the art, in accordance with the present claims. Therefore, the device architecture depicted in FIG. 3 should be treated as exemplary only and should not be treated as limiting the scope of the present disclosure.

The processor (310) is capable of controlling operation of the device (309). More specifically, the processor (310) may be operable to control and interact with multiple components installed in the device (309), as shown in FIG. 3. For instance, the memory (320) can store program instructions that are executable by the processor (310) and data. The process described herein may be stored in the form of program instructions in the memory (320) for execution by the processor (310). The communication unit (330) can allow the device (309) to transmit data to and receive data from one or more external devices via a communication network. The input unit (340) can enable the device (309) to receive input of various types, such as audio/visual input, user input, data input, and the like. To this end, the input unit (340) may be composed of multiple input devices for accepting input of various types, including, for instance, one or more cameras (342; i.e., an “image acquisition unit”), touch panel (344), microphone (not shown), sensors (346), keyboards, mice, one or more buttons or switches (not shown), and so forth. The term “image acquisition unit,” as used herein, may refer to the camera (342), but is not limited thereto. The input devices included in the input (340) may be manipulated by a user. The output unit (350) can display information on the display screen (352) for a user to view. The display screen (352) can also be configured to accept one or more inputs, such as a user tapping or pressing the screen (352), through a variety of mechanisms known in the art. The output unit (350) may further include a light source (354). The device (309) is illustrated as a single component, but the device may also be composed of multiple, separate components that are connected together and interact with each other during use.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

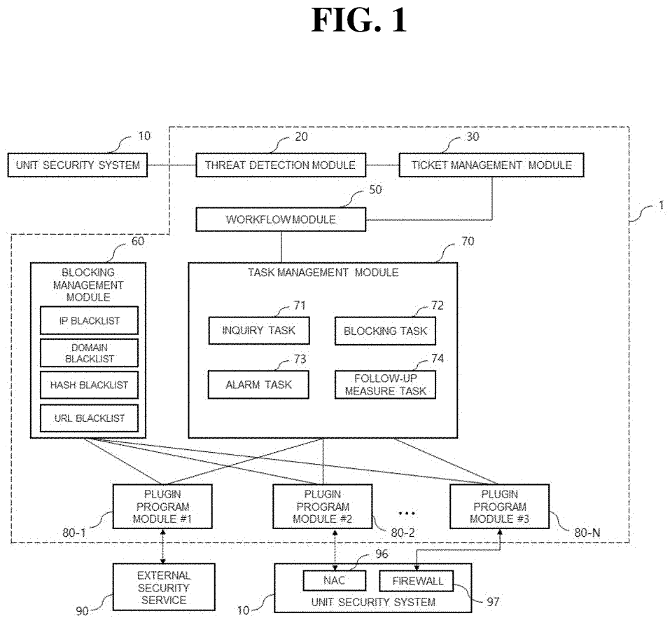

FIG. 1 shows a platform (1) carrying out the method for responding to a threat according to the present disclosure, and external devices.

The platform (1) comprises a threat detection module (20), a ticket management module (30), a workflow module (50), a blocking management module (60), a task management module (70) and plugin program modules (80-1, 80-2, . . . , 80-N).

A unit security system (10) can be a firewall, a web firewall (WAF), an intrusion detection system (IDS), an intrusion prevention system (IPS), an anti-virus and the like that provide a unit security function for a network and system layers and generate a log when it detects a threat.

The threat detection module (20) receives security log from the unit security system (10); standardizes the log; analyzes the standardized log; detects a threat by using various methods such as pattern matching, the same data reduction, real time event correlation analysis of data received from different devices, statistical correlation analysis, anomaly detection based on machine learning and the like; and generates a ticket.

The ticket management module (30) preserves the detected threat and the detection rationale thereof; assigns the ticket to a person who is in charge of analyzing the threat and responding to the threat; and notifies the ticket generation by email, text message and the like to the person. The ticket management module (30) requests the workflow module to carry out the workflow which is previously designated for the threat type of the ticket.

The workflow module (50) carries out the tasks according to the pre-designated workflow.

The blocking management module (60) can include an IP blacklist, a domain blacklist, a HASH blacklist, a URL blacklist and the like. The blacklist of the blocking management module (60) can be updated in real time, non-periodically or periodically when an event occurs. The task management module (70) can include an inquiry task (71), a blocking task (72), a notification task (73), a follow-up action task (74) and the like. Other task can be added or some of the tasks can be eliminated.

The inquiry task (71) can include for example, an inquiry about IP reputation, an inquiry about asset information, an inquiry about WHOIS, an inquiry about GEOIP, an inquiry about URL, a sandbox analysis, an inquiry about previous alarm, an EDR host scan and the like.

The inquiry about IP reputation is for checking whether an external IP which is accessed from within has attacked other organization. The IP in the ticket is extracted and then API of the security solution called by the plugin program module checks the reputation of the external IP.

The inquiry about asset information is for evaluating the risk of blocking by checking the host information. For example, blocking the IP of critical service can lead to customer service failures. If a service infrastructure is based on Active Directory, the asset information can be retrieved from the Directory through LDAP protocol. If NAC (96) is built by a unit security system (10), the asset information can be retrieved from DB or API called by the plugin program module.

The inquiry about WHOIS is for checking the domain or IP information which is determined as a threat. The critical information among the retrieved information is creation date of the domain. A malware should be connected to a server controlled by an attacker. Generally, the domain of the server connected to the malware is used only for a short period and then is discarded since a fixed domain or IP can be easily blocked. If an old domain with a good reputation is determined to be a threat, it can be regarded that the infrastructure of the domain is attacked and is used as a threat tool.

The inquiry about GEOIP is for checking the geographical information of IP. For example, MaxMind.com provides the service. If a person who works only in its domestic area tries access from foreign country through VPN, it is regarded from the inquiry result that the access is abnormal.

The inquiry about URL is for checking the reputation on the URL. For example, the inquiry about URL can be carried out at virustotal.com or by API.

The inquiry about HASH is for checking whether a binary is known binary or a malicious binary. For example, the hash included in the ticket, for example, MD5 hash list is extracted and then the extracted hash is analyzed by API of the security solution called by the plugin program module.

The sandbox analysis executes a suspicious binary to analyze the behavior of the binary. The behavior to be analyzed includes a process execution, a registration of registry, file drop and the like. Cisco Secure Malware Analytics (formerly Cisco Threat Grid), Joe Sandbox and the like are the examples of the external security solution providing the service.

The EDR host scan is for checking installation history or propagation history to determine whether the same binary is found in other hosts. EDR server can issue a file retrieval command to every host where EDR agent is installed and collect retrieval results non-periodically.

The blocking task (72) includes, for example, a deactivation of the account which is determined to be a threat, IP blocking, HASH blocking, URL blocking, domain blocking and the like. The blocking management module (60) can update the blacklist by referring to the blocked items.

The notification task (73) is for notifying a threat to a related person. The task can be carried out by a collaboration solution such as SLACK® and the like.

The follow-up action task (74) can include, for example, making whitelist, removal of malware, registration of blacklist, preparation of responding report, sharing IoC information and the like.

The plugin program module (80-1, 80-2, . . . , 80-N) can carry out a remote API communication with various external security services (90) and/or various unit security systems (10; for example, NAC (96), firewall (97) and the like). The plugin program module can be provided for each security solution or each security unit. Alternatively, single plugin program module can be provided to carry out the remote API communication with a plurality of security solutions or security units.

The security service in this specification is an external security intelligence service that a security analyst uses to determine whether the threat detected from basic security-associated data (for example, log data) is a real threat to the system. The security services can be VIRUSTOTAL™, AbuseIPDB, Abuse.ch, Secudium Intelligence provided by SK Infosec, Threat Recon of NSHC, Malwares.com of Saint Security and the like.

The unit security system (10) can be a firewall, IDS (Intrusion Detection System), IPS (Intrusion Prevention System), WAF (Web Application Firewall), DDos protection system, APT protection system, anti-spam mail system, WIPS (Wireless Intrusion Prevention System), SWG (Secure Web Gate), anti-virus, Media Access Control, DRM (Digital Rights Management), DLP (Data Loss Prevention), system for preventing forgery of application, secure USB, OTP (one time password), DB access control, DB encryption, anti-webshell, encryption key management, network-associated device, an access control system, a network vulnerability diagnosis system, a source code vulnerability diagnosis system, a detection system of PC private information, a monitoring system of private information, a detection system of server private information, an elevation of Windows administrator privileges, a patch management and the like.

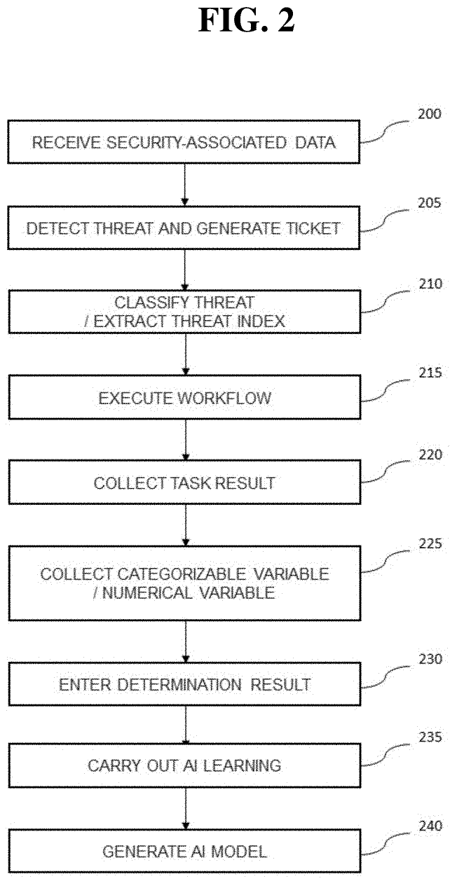

The method for responding to threat according to the present disclosure will be described with reference to FIG. 2.

In the step (200), the threat detection module (20) receives a security-associated data from the unit security system (10). For example, the security-associated data can be alarm log.

The following log data is exemplarily used for description of the present disclosure. The log data is generated by a secure system called “SNIPER IPS” according to UDP SYSLOG protocol.

```
  [SNIPER-0005]
  [Attack_Name=(30076)UDR_ATTACK_MYSQL_login_success_1269_120323],
[Time=2014/12/12 14:33:46], [Hacker=175.126.56.99], [Victim=10.202.215.101],
[Protocol=tcp/3306], [Risk=Medium], [Handling=Alarm], [Information=], [SrcPort=59939],
[HackType=02401]
```

The log data can be normalized (standardized) to have the following fields to be processed by the platform (1) of the present disclosure. The normalization can be carried out at the threat detection module (20). Alternatively, the normalization can be carried out by a normalization module (not illustrated) which is provided separately from the threat detection module (20).

_time=2014-12-12 14:33:46 (time, date type)

src_ip=175.126.56.99 (source IP, IP address type)

src_port=59939 (source port, 32-bit integer type)

dst_ip=10.202.215.101 (destination IP, IP address type)

dst_port=3306 (destination port, 32-bit integer type)

protocol=TCP (protocol, string type)

action=DETECT (response, string type)

risk=MEDIUM (degree of danger, string type)

signature=(30076)UDR_ATTACK_MYSQL_login_success_1269_120323 (attack name, string type)

In the step (205), the threat detection module (20) detects the threat according to a threat scenario and generates a ticket which relates to the detected threat.

The threat detection module (20) receiving the normalized security data generates an event and a ticket. The event can be standardized as follows:

_time: date type, time

guid: string type, identifier of the event

ticket_guid: string type, identifier of the ticket

logger_id: 32-bit inter type, identifier of collector

logger_name: string type, name of collector

priority: string type, importance (LOW, MEDIUM, HIGH)

rule_type: string type, category of detection scenario (STREAM, REAL TIME, BATCH)

rule_id: 32-bit integer type, identifier of detection scenario

user: string type, user account

src_ip: IP address type, source IP

src_port: 32-bit integer type, source port

dst_ip: IP address type, destination IP

dst_port: 32-bit integer type, destination port

protocol: string type, protocol (TCP/UDP/ICMP/IGMP)

src_country: string type, ISO-2 code of source country (US, KR and the like)

dst_country: string type, ISO-2 code of destination country

action: string type, response (DETECT, BLOCK and the like)

msg: string type, event message

A plurality of events can be matched to one ticket. The threat detection module (20) can generate the ticket for the above event, which has the following fields:

time: 2014-12-12 14:33:46

importance: MEDIUM

category of detection scenario: intrusion to account

name of detection scenario: unauthorized DB access attempt

data source: SNIPER IPS #1

source IP: 175.126.56.99

source port: 59939

destination IP: 10.202.215.101

destination port: 3306

protocol: TCP

number of occurrences: 1

account: none

message: (30076)UDR_ATTACK_MYSQL_login_success_1269_120323

The category of detection scenario includes “exploit attempt,” “malware infection,” “account hijacking,” and the like. A workflow is defined according to the category of detection scenario. When the ticket of threat detection is generated, standardized fields such as source IP, source port, destination IP, destination port, protocol, account, domain, URL, HASH and the like are extracted from the security-associated basic data.

The ticket management module (30) requests the workflow module (50) to analyze the threat and respond to the threat. In the step (210), the workflow module (50) extracts the category of the threat and threat-associated index (for example, IP, domain, URL, HASH and the like) from the ticket. In the step (215), the workflow responding to the threat is carried out. The workflow is a task including inquiry, blocking, isolation, alarm, follow-up action and the like. A task can be carried out in parallel with other task if the tasks have no dependencies each other. If tasks have dependencies each other, a task should be carried out after the task which should be performed earlier is carried out. For example, a task that blocks a specific IP as an attacker's IP should be carried out after the task that determines whether the detection is correct or not is carried out.

The ticket management module (30) generates a ticket including the artifacts such as log, IP address, HASH, domain, email address, registry key and the like which relate to the threat. A ticket is a work unit which requests a security manager to analyze it and respond thereto.

The security manager records analysis results of the ticket and uploads the results in the ticket management module (30). The security manager can refer to prior tickets in threat analysis. Generally, the ticket can be processed in the order of “newly-issued;” “assignment;” “being-processed;” “asking for approval;” and “approval” or “rejected.”

The ticket management module (30) can show the workflow and the task which are determined according to the category of the threat when a security manager inquires the ticket.

The ticket management module (30) allows the workflow module (50) to carry out the predetermined workflow.

The workflow module (50) carries out the task and incorporates the task result to the ticket in the step (220). The task and the incorporated result can be as follows:

### 1. Inquiry Task

[Inquiry about IP Reputation]

Incorporated to the ticket is the inquiry result about the reputation of source IP (175.126.56.99), which is received from the external security service such as AbuseIPDB, VirusTotal and the like. The task can be carried out by a plugin program module which provides the interface that allows the inquiry about IP reputation by the external security service. The plugin can be implemented by use of API provided by the external security service.

The exemplary inquiry result of the task can be as follows:
Response from VirusTotal (Exemplary response for 178.156.202.86):

Type=Malicious, Number of Reports: 3, Country=RO, ASN=48874, AS owner=Hostmaze Inc, Malicious URL=http://178.156.202.86:8080/syn (detected 7/71, 2019-07-04 04:41:59), Malware Hash=07c7a954306ebe09c9a6980283711e319105d77d8857699b5fc0fab0a71068da, Domain=joindebo.com
Response from AbuseIPDB:

Type=Malicious, Explanation=Romania, score 100, Number of Reports=47, Country=Romania, Type of Attack=Brute-Force, Blog Spam, Web Spam, Bad Web Bot, Exploited Host, Port Scan, Hacking, Web App Attack

[Inquiry about Asset Information]

Incorporated to the ticket is the inquiry result about the asset information for the destination IP (10.202.215.101), which is received from NAC (96). The task can be carried out NAC plugin module which provides the common interface for the inquiry about the asset information. The plugin can be implemented by API provided by the device manufacturer. For example, the inquiry result can be as follows:
Host name=KYLE, Type: server, IP=10.202.215.101, MAC=AA:BB:CC:DD:EE:FF, platform=Linux, node policy=basic policy

[Inquiry about GEOIP]

Country, ASN, and latitude/longitude for source IP (175.126.56.99) are inquired. The inquiry about GEOIP can be carried out by a plugin program module which allows API communication with the external security service providing GEOIP inquiry service. The geographical information of the source IP can be as follows:
Country=KR, latitude=37.511199951171875, longitude=126.9740982055664, ASN=AS9318 SK Broadband Co Ltd

[Inquiry about prior information]

The prior information stored in the platform (1) can be inquired. For example, the following information can be obtained.

Number of attack types in the last 24 hours=3, Number of attacks in the last 24 hours=8,

Number of attack types in the last 1 week=5, Number of attacks in the last 1 week=20

### 2. Blocking Task

[Determination as to whether the detection is correct or not]

Determination as to whether the detection is correct or not is carried out by referring to the information obtained in the inquiry task.

For example, it has high possibility that the detection of the attack is correct if the two or more threat intelligences determine that the IP is malicious.

Further, determination as to whether the detection is correct or not can be carried out by machine learning.

[Determination of Blocking]

Determination of blocking is carried out by referring to the information obtained in the inquiry task.

If the source IP is an external IP and the reputation is “malicious,” it is likely that it is determined to block the IP.

Determination of blocking can be carried out by machine learning.

[Blocking Task]

Blocking is carried out after it is determined that a specific IP should be blocked.
The blocked IP is added to the blacklist.
The blocked IP added to the blacklist can be forwarded to the plugin having a function of blocking IP.

### 3. Alarm Task

The task results can be forwarded to a security manager by email and the like.

In the step (225), categorizable variables and numerical variables are collected from the task results. The variables are classified to categorizable variables or numerical variables as follows:

According to VirusTotal service, how many anti-virus engines diagnose a specific IP as malicious by inquiry about MD5 reputation?
API response: 8 (numerical variable)

According to AbuseIPDB service, how many attack attempts are reported by inquiry about IP reputation?
API response: 98 (numerical variable)

According to AbuseIPDB service, what is the probability that a specific IP is determined as malicious by inquiry about IP reputation?
API response: 37% (numerical variable)

What is the type of the asset information?
API response: web server (categorizable variable)

Is it determined from the sandbox analysis that the host file is modified?
API response: Yes (categorizable variable)

The reason for classifying the variables into categorizable variable and numerical variable is to use the variables as input features for AI learning model.

In the step (230), a security manager enters the determination result to the system. The determination result and the input features are accumulated as AI learning data. In the step (235), AI learning, for example, supervised learning is carried out. The supervised learning is carried out based on the determination result and the input features to establish AI model (step 240).

Once the AI model is established, the response to the threat can be automatically carried out based on the task result, the categorized variables and numerical variables collected in the step (225). The AI model can be updated by periodic or non-periodic learning. If it is determined from, for example, K-Fold Cross Validation, that the updated AI model is more accurate than the previous AI model, the updated AI model replaces the previous AI model.

Although the present disclosure has been described with reference to accompanying drawings, the scope of the present disclosure is determined by the claims described below and should not be interpreted as being restricted by the embodiments and/or drawings described above. It should be clearly understood that improvements, changes and modifications of the present disclosure disclosed in the claims and apparent to those skilled in the art also fall within the scope of the present disclosure. Accordingly, this description is to be taken only by way of example and not to otherwise limit the scope of the embodiments herein.

1. A computer-implemented method for responding to network threat, carried out by a threat responding device including a threat detection module, a ticket management module, a workflow module and a plugin program module, the method comprising:
receiving, by the threat detection module, security-associated data from a unit security system;
generating, by the threat detection module, a ticket based on the received security-associated data;
requesting, by the ticket management module, ticket analysis and response to the workflow module;
calling, by the plugin program module, AIP of the unit security system or an external security service; and
carrying out, by the workflow module, a task according to API communication with the called unit security system or the external security service;
wherein the task comprises at least one of an inquiry task, a blocking task, an alarm task, and a follow-up action task;
wherein the inquiry task comprises at least one of an inquiry about IP reputation, an inquiry about asset information, an inquiry about WHOIS, an inquiry about GEOIP, an inquiry about URL, an inquiry about HASH, an inquiry about sandbox, an inquiry about prior information; and
wherein the blocking task comprises at least one of account deactivation, IP blocking, HASH blocking, URL blocking and domain blocking.

2. The method according to claim 1, wherein the plugin program module calls API of the unit security system or the external security service by a query.

3. The method according to claim 1, wherein a workflow instance of each ticket comprises attack index variable and general variable; and each task carries out I/O in the general variable space.

4. The method according to claim 3, wherein the threat responding device further comprise an AI learning module that receives at least one of categorizable variable extracted from the general variable and determination as to whether an attack index is malicious for each module, the received information being input feature of the AI learning module.

5. The method according to claim 4, further comprising,
accumulating, by the AI learning module, the input feature and the response result provided by a security analyst;
carrying out, by the AI learning module, a supervised learning with the accumulated data to generate an AI learning model; and
determining, by the workflow module, a threat according to the AI learning model and responding to the treat.

6. A computer-implemented system comprising one or more processors and one or more computer-readable media storing computer-executable instructions that, when executed, cause the one or more processors to perform a method comprising:
receiving security data from a unit security-associated system;
generating a ticket based on the received security-associated data;
requesting ticket analysis and response to the workflow module;
calling AIP of the unit security system or an external security service; and
carrying out a task according to API communication with the called unit security system or the external security service;
wherein the task comprises at least one of an inquiry task, a blocking task, an alarm task, and a follow-up action task;
wherein the inquiry task comprises at least one of an inquiry about IP reputation, an inquiry about asset information, an inquiry about WHOIS, an inquiry about GEOIP, an inquiry about URL, an inquiry about HASH, an inquiry about sandbox, an inquiry about prior information; and
wherein the blocking task comprises at least one of account deactivation, IP blocking, HASH blocking, URL blocking and domain blocking.

7. A computer program product comprising one or more computer-readable storage media and program instructions stored in at least one of the one or more storage media, the program instructions executable by a processor to cause the processor to perform a method comprising:
receiving security data from a unit security-associated system;
generating a ticket based on the received security-associated data;
requesting ticket analysis and response to the workflow module;
calling AIP of the unit security system or an external security service; and
carrying out a task according to API communication with the called unit security system or the external security service;
wherein the task comprises at least one of an inquiry task, a blocking task, an alarm task, and a follow-up action task;
wherein the inquiry task comprises at least one of an inquiry about IP reputation, an inquiry about asset information, an inquiry about WHOIS, an inquiry about GEOIP, an inquiry about URL, an inquiry about HASH, an inquiry about sandbox, an inquiry about prior information; and
wherein the blocking task comprises at least one of account deactivation, IP blocking, HASH blocking, URL blocking and domain blocking.
